(19) United States
(12) Patent Application Publication
(10) Pub. No.: US 2026/0238924 A1
(43) Pub. Date: Aug. 13, 2026

(54) ELECTRODYNAMIC MEMS LOUDSPEAKER

(71) Applicant: ZHEJIANG NORMAL UNIVERSITY, Jinhua (CN)

(72) Inventors: CLARENCE AUGUSTINE TECK HUO TEE, Jinhua (CN); BURHANUDDIN YEOP MAJLIS, Selangor (MY); WEY PING YEO, Selangor (MY); GANDI SUGANDI, Selangor (MY)

(21) Appl. No.: 19/078,189

(22) Filed: Mar. 12, 2025

(30) Foreign Application Priority Data
Feb. 13, 2025 (CN) 202510160387.5

(51) Int. Cl. H04R 9/02; H04R 1/06; H04R 7/04; H04R 9/04; H04R 9/06

(52) U.S. Cl. CPC H04R 9/025; H04R 1/06; H04R 7/04; H04R 9/046; H04R 9/06; H04R 2201/003; H04R 2307/023

(57) ABSTRACT

Disclosed is an electrodynamic micro-electromechanical system (MEMS) loudspeaker. The loudspeaker is provided with a pair of stators and a diaphragm placed between the stators. The loudspeaker generates an acoustic output according to an input electroacoustic signal. The movable part is related to performance of the electrodynamic MEMS loudspeaker, because it is a symmetrical structure of a film-conductor connector, and a rigid polyimide diaphragm is suspended on a diagonal spring structure and uniformly distributed on an elastic diaphragm. Further, this structure enables to optimize a frequency bandwidth, thereby achieving a larger bandwidth. A multi-turn planar micro-coil structure can be fabricated at a top and/or bottom of the diaphragm in a single-layer or double-layer form to enhance efficiency of the MEMS loudspeaker.

### CROSS-REFERENCE TO RELATED APPLICATIONS

This application claims priority to Chinese Patent Application No. 202510160387.5, filed on Feb. 13, 2025, which is hereby incorporated by reference in its entirety.

### TECHNICAL FIELD

The present disclosure relates to the technical field of micro-electromechanical system (MEMS), and in particular to production and construction of electrodynamic loudspeakers based on MEMS technology.

### BACKGROUND

An electrostatic loudspeaker (ESL) is a loudspeaker that produces sounds by vibrating a taut diaphragm (hereinafter referred to as “the diaphragm”). Vibration of the diaphragm is caused by a varying high-voltage electrostatic field, and the electrostatic field changes with an input audio signal. The diaphragm is usually composed of a thin, flat plastic sheet coated with a conductive material such as graphite or a conductive polymer, and suspended between two conductive grids (hereinafter referred to as “stators”), and there exists a small air gap between the diaphragm and each stator.

To achieve low distortion, the diaphragm should maintain a uniform constant charge on a surface thereof rather than a uniform constant voltage. An ideal charge is uniform such that electrostatic forces are approximately equal across an entire surface of the diaphragm. When an electrostatic force in some parts of the diaphragm is significantly greater than that in other parts thereof, the diaphragm will physically deform instead of smoothly moving with oscillation of audio signals each time.

A micro loudspeaker, or a mini loudspeaker, is a transducer capable of converting electrical signals into acoustic signals. Conversion from the electrical signal to the acoustic signal usually does not involve direct electro-acoustic conversion; and the electrical signal is first converted into mechanical vibration and then converted into an acoustic signal. Generally, a conventional micro loudspeaker is driven by an electrodynamic mechanism. An electrodynamic micro loudspeaker further includes a permanent magnet and a coil wound around the permanent magnet, the coil is connected to a diaphragm or vibrating diaphragm, and the diaphragm is usually made of an elastic film material with a lower Young's modulus. The diaphragm of the micro loudspeaker serves not only as an acoustic radiator but also as a suspension component.

The MEMS loudspeaker or the MEMS micro loudspeaker is usually a miniaturized loudspeaker manufactured by using MEMS technology. At present, development of MEMS loudspeakers aims to meet a growing market demand for audio devices embedded in multimedia and mobile devices, such as hearing aids, headphones (earbuds), mobile phones, smartphones, and tablet PCs. These devices also need to be thinner without compromising performance and quality.

Based on the above discussion, it seems necessary to develop an intelligent MEMS loudspeaker, and main challenges lie in achieving a better balance between power efficiency, higher volume, better acoustic quality, and overall integration of the MEMS loudspeaker.

### SUMMARY

In order to overcome the defects in the prior art, an objective of the present disclosure is to provide a device for production and construction of electrodynamic micro-electromechanical system (MEMS) loudspeakers, so as to solve some of the technical problems raised in the above Background.

To achieve the above objective, the present disclosure provides a device for production and construction of electrodynamic MEMS loudspeakers. The MEMS loudspeaker includes at least two parts, and the two parts include at least a static part and a movable part. The MEMS loudspeaker further includes: (a) a static part, configured to include a silicon framework as a permanent magnet platform, at least an acoustic aperture and a permanent magnet; (b) a movable part, configured to include at least one elastic square-shaped diaphragm, a single planar micro-coil, a connector and a plurality of contact pads; and (c) a square and folded structure, configured to be formed by an interaction between a current-carrying planar coil and a magnetic field produced by the permanent magnet, thereby generating a specific acoustic pressure around a front part of the diaphragm.

Further, a device structure for constructing an electrodynamic MEMS loudspeaker is provided, and the MEMS loudspeaker includes:
(a) a static part, a movable part, and an acoustic generation mechanism;
(b) the static part includes a silicon framework configured as a platform for an acoustic aperture and a permanent magnet;
(c) an elastic square-shaped diaphragm, fixed at a top of the silicon framework and provided with a connecting arm and a plurality of contact pads connected to a planar micro-coil;
(d) a plurality of connecting arms of thin conductor, distributed diagonally at a center of an elastic diaphragm and configured for connection with the planar micro-coil through the plurality of the connecting arms; and
(e) the plurality of the connecting arms of thin conductor, and the connecting arms are embedded in a center of at least one elastic diaphragm.

A surface of the diaphragm can be further enhanced by patterning (nano-texture) to minimize air resistance to the diaphragm and optimize acoustic wave propagation, which will further enhance acoustic performance.

The features and advantages of the present disclosure will be described in detail with reference to the examples and the accompanying drawings.

### BRIEF DESCRIPTION OF DRAWINGS

In the accompanying drawings, the same reference numbers may refer to the same or functionally similar elements. These reference numbers are used for detailed description to illustrate various embodiments of the present disclosure and explain various aspects and advantages of the present disclosure.

FIG. 1 is a perspective view of a cross section of an electrodynamic MEMS loudspeaker of the prior art.

FIG. 2 is a perspective view of a cross section of an electrodynamic MEMS loudspeaker of the present disclosure.

FIG. 3 is a perspective view of an enlarged cross-section of an electrodynamic MEMS loudspeaker of the present disclosure.

FIG. 4 is an exploded perspective view of various parts of an electrodynamic MEMS loudspeaker of the present disclosure.

FIG. 5 is an exploded perspective view of a movable part of an electrodynamic MEMS loudspeaker of the present disclosure.

FIG. 6 is another perspective view of a movable part of an electrodynamic MEMS loudspeaker of the present disclosure, with reference to FIG. 2.

FIGS. 7-9 illustrate an alternative arm structure that is configured to connect a membrane layer formed by polyimide in an electrodynamic MEMS loudspeaker of the present disclosure, as shown in FIG. 2.

### DESCRIPTION OF EMBODIMENTS

For making the objectives, technical solutions and advantages of the present disclosure clearer, the present disclosure will be described in further detail below with reference to the accompanying drawings and the examples. It should be understood that the specific examples described herein are merely illustrative of the present disclosure and are not intended to limit the present disclosure. In addition, in the following descriptions, descriptions of well-known structures and technologies are omitted in order to avoid unnecessarily obscuring the concepts of the present disclosure.

In the descriptions of the present disclosure, it should be noted that when an element is referred to as being “fixed to” or “arranged on” another element, the element may be directly or indirectly on another element. When an element is referred to as being “connected to” another element, the element may be directly or indirectly connected to another element.

In the descriptions of the present disclosure, it should be noted that the terms “center”, “length”, “width”, “thickness”, “upper”, “lower”, “front”, “back”, “left”, “right”, “vertical”, “horizontal”, “top”, “bottom”, “inner”, “outer”, etc. indicate orientation or position relations based on those shown in the accompanying drawings, or of common placement when the product of the present disclosure is used, which are only for ease of description of the present disclosure and for simplicity of description, and are not intended to indicate or imply that the referenced device or element must have a particular orientation and be constructed and operated in a particular orientation, and thus may not be construed as a limitation on the present disclosure. Moreover, the terms “first”, “second”, “third”, etc. are used merely to distinguish between descriptions and may not be construed as indication or implication of relative importance. Thus, a feature defined with “first” and “second” may explicitly or implicitly include one or more of the features. In the description of the present disclosure, “a plurality of” means two or more, unless expressly specified otherwise. “Several” means one or more, unless expressly specified otherwise.

In the description of the present disclosure, it should be further noted that, unless otherwise clearly specified, meanings of terms “arrange”, “mount”, “connected” and “connect” should be understood in a board sense. For example, the connection may be a fixed connection, a detachable connection, an integral connection; may be a mechanical connection or an electrical connection; may be a direct connection or an indirect connection by using an intermediate medium; or may be intercommunication between two components. For those of ordinary skill in the art, the specific meanings of the above terms in the present disclosure may be understood according to specific circumstances.

The following detailed description aims to provide exemplary implementations to those skilled in the art and is not intended to limit the present disclosure to the explicitly disclosed content, because those skilled in the art will understand that changes can be made as alternatives and that these changes fall within the above scope of the present disclosure.

In general, the present disclosure relates to a micro-electromechanical system (MEMS) loudspeaker, and the MEMS loudspeaker includes a diaphragm attached to a substrate and an electrode attached to the substrate, where the diaphragm and the electrode have a same resonance frequency.

In the present disclosure, the term “attached to a substrate” particularly refers to that the component (such as the diaphragm or the electrode) can be attached to the substrate and even form part of the substrate, i.e., being fixedly connected to the substrate. In particular, the term can further include that the substrate and the diaphragm or the electrode are fixedly connected together through a connecting element, or the diaphragm and/or the electrode form an integral part of the substrate.

According to an example of the present disclosure, an improved apparatus structure is provided to form an electrodynamic MEMS loudspeaker, and a structure of the MEMS loudspeaker includes at least one of the following parts: a static part, a movable part, and an acoustic generation mechanism, where the static part includes a silicon framework as a permanent magnet platform, an acoustic aperture, and a permanent magnet; and an elastic square-shaped diaphragm is fixed to a top of the silicon framework and connected to a planar micro-coil and a plurality of contact pads. Further, connecting arms of thin conductor are provided and obliquely distributed at a center of the square elastic diaphragm, and are configured for connection with the planar micro-coil through a plurality of connecting arms; and a plurality of the connecting arms of thin conductor are embedded in a center of at least one elastic diaphragm or polydimethylsiloxane (PDMS) diaphragm.

The present disclosure will be discussed in detail in combination with the accompanying drawings and with reference to the figures individually or in combination.

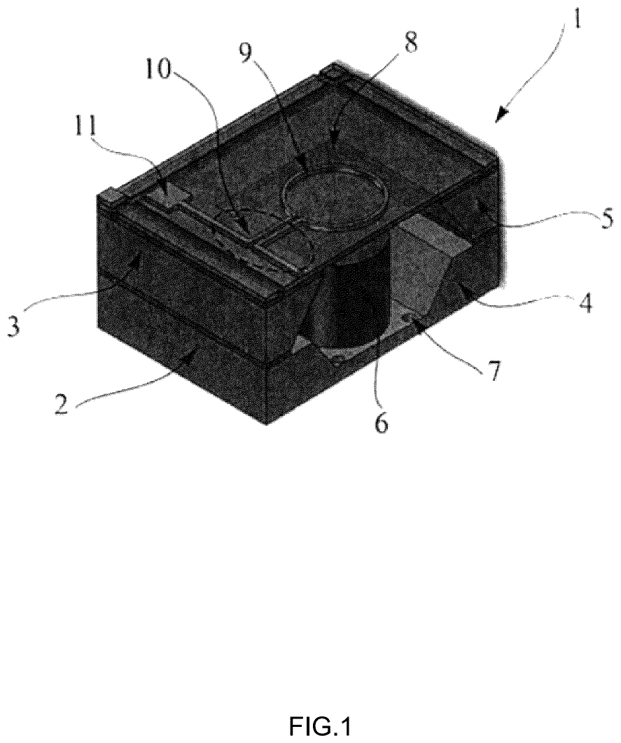

As illustrated in FIG. 1, an electrodynamic MEMS loudspeaker (1) in an example includes at least two parts, i.e., a static part (2) and a movable part (3), or an acoustic generation mechanism (not shown in the figure). The static part (2) includes a silicon framework (4) as a permanent magnet platform, an acoustic aperture (7), and a permanent magnet (6). The movable part (3) includes an elastic square-shaped diaphragm (8), a single planar micro-coil (9), a connector (10), and contact pads (11).

The diaphragm (8) shown in FIG. 1 has a square and folded structure. Normally, the flexible thin diaphragm (8) embedded is made of a material with a low Young's modulus, and the material enables to easily vibrate and deflect under the action of a low external force. Further, microstructural roughness can minimize air resistance to the diaphragm and optimize acoustic wave propagation, which will further enhance acoustic performance.

The square and folded structure is formed by an interaction between the current-carrying planar coil (9) and a magnetic field produced by the permanent magnet (6), which is suitable for generating an acoustic pressure around a front part of the diaphragm. However, a structure of the square diaphragm (8) formed by the thick planar coil (9) and the asymmetrical connecting arms (12) has some defects, particularly including correlation with displacement of the diaphragm (unlike piston motion), high-frequency resonance, and an impact on acoustic performance of a micro loudspeaker.

Therefore, the present disclosure aims to solve the above problems in the prior art. The present disclosure relates to an electrodynamic MEMS loudspeaker (1), and more specifically, the MEMS loudspeaker (1) includes at least two parts, i.e., a static part (2) and a movable part (3) or an acoustic generation mechanism. The static part (2) includes a silicon framework (4), an acoustic aperture (7) arranged on the silicon framework (4), and a permanent magnet (6). The static part is structurally similar to that in previous prior art. However, in this example, the movable part (3) differs from the previous structure and includes an elastic square-shaped diaphragm (8) fixed at a top of an upper silicon framework (5), and connecting arms (12) connected to a planar micro-coil (9) and contact pads. The connecting arms (12) of thin conductor are obliquely distributed at a center of the elastic diaphragm (8) and are configured for connection with the planar micro-coil (9) through the connecting arms (12), and the elastic diaphragm is connected to the connecting arms through a connecting portion (13). The connecting arms (12) of thin conductor are embedded in a center of the elastic diaphragm or PDMS diaphragm and then obliquely distributed, and protected by polyimide to form the connector (10) as a spring diaphragm structure. The polyimide layer also serves as a dielectric layer, which isolates the planar micro-coil (9) and the connecting arms (12).

The entire system and an electronic loudspeaker system can be connected (or contained) in an enterprise network. The enterprise network may further include email or exchange servers, enterprise application servers, internal app store servers, authentication (AAA) servers, directory servers, Virtual Private Network (VPN)/SSL gateways, firewalls, and other servers and components. The email or exchange server may include Exchange Active Sync (EAS) or other systems that have functions of contact, calendar, task and email synchronization, and these systems are synchronized with mobile devices through Active Sync-enabled servers. Other synchronization products can also be used. Mobile devices can access or utilize these enterprise systems or related functions.

In some examples, servers and/or mobile development services may be hosted and operated by one or more third-party service providers or can be accessed by developers through a network. The network can be a wired and/or wireless network of any appropriate type, such as an Internet network or a private network, which allows developers to access the MEMS loudspeaker through their computers.

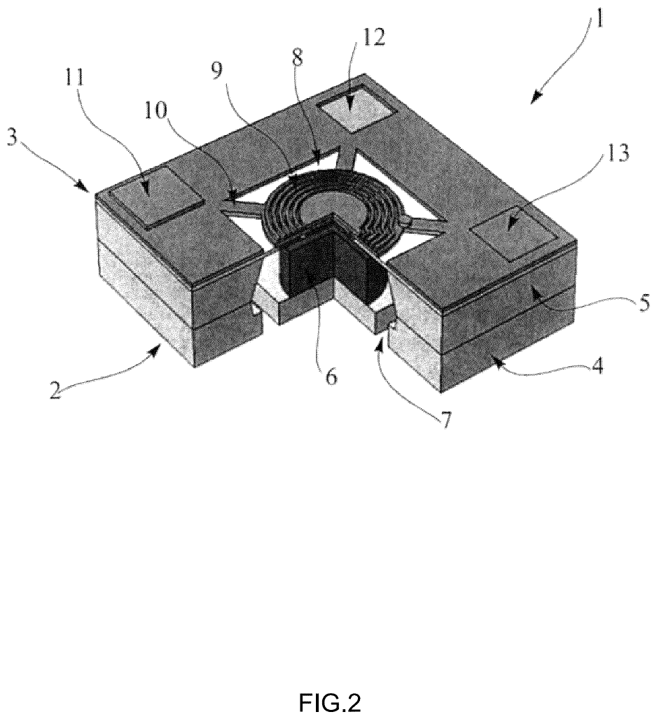

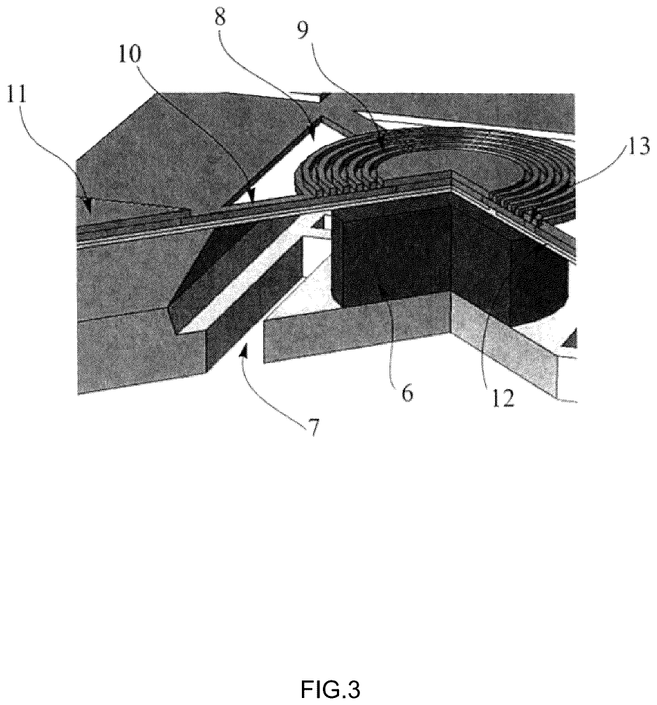

Therefore, the present disclosure includes the MEMS loudspeaker structure (1) briefly described above, and the structure is a symmetrical structure that can be displaced from the diaphragm like a piston to generate an acoustic pressure. FIG. 2 is a perspective view of a cross section of an electrodynamic MEMS loudspeaker of a new structure. FIG. 3 is an enlarged perspective view of an electrodynamic MEMS loudspeaker of a new structure, which facilitates detailed view of the present example.

The described electrodynamic mems loudspeaker device includes two micromachined silicon frameworks, where the first framework is a micromachined flexible film or diaphragm, serving as an acoustic generation part, and the second framework is a micromachined silicon wafer that serves as a permanent magnet platform and is provided with an acoustic aperture to release air in a cavity or chamber beneath the diaphragm. The two silicon frameworks are bonded together to form an integrated electrodynamic MEMS loudspeaker device, as shown in FIGS. 1 and 2. The first silicon framework is deemed as the movable part for generating an acoustic pressure, and the second framework serves as the static part of the electrodynamic MEMS loudspeaker.

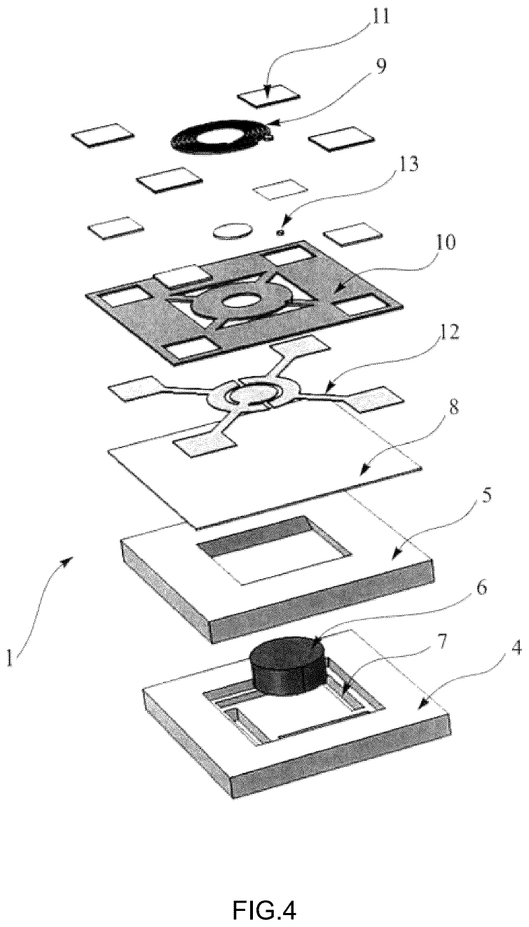

In FIG. 4, an exploded perspective view of components of a present example of the electrodynamic MEMS loudspeaker (1) shows the components with main dynamic characteristics determined (those marked from 4 to 13 in the figure). The static part (2) includes a silicon framework (4) as an acoustic aperture platform, an acoustic aperture (7) and a permanent magnet (6). The movable part (3) of the electrodynamic MEMS loudspeaker (1) causes air pressure differences in the diaphragm (8) or a dynamic structure. The diaphragm (8) is connected to the center of the diaphragm through an electrodynamic actuator and forced to move. To optimize the displacement of the diaphragm, an elastic material or PDMS material is used, and to maintain linear movement of the diaphragm, the thin connecting arms (12) are symmetrically distributed on the diaphragm to keep movement of the diaphragm like a piston.

The thin connecting arms (12) are arranged in a way of individually isolating and then protected by polyimide to prevent cracking of the diaphragm during the movement. The polyimide also acts as a dielectric layer that isolates the connecting arms (12) from the planar micro-coil (9). A rigid diaphragm structure suspended on four diagonal spring arms is further formed on the polyimide layer. To ensure transmission of acoustic wave electrical signals to the planar micro-coil and to vibrate the diaphragm, electrical signals are connected to the contact pads (11) through connectors (13).

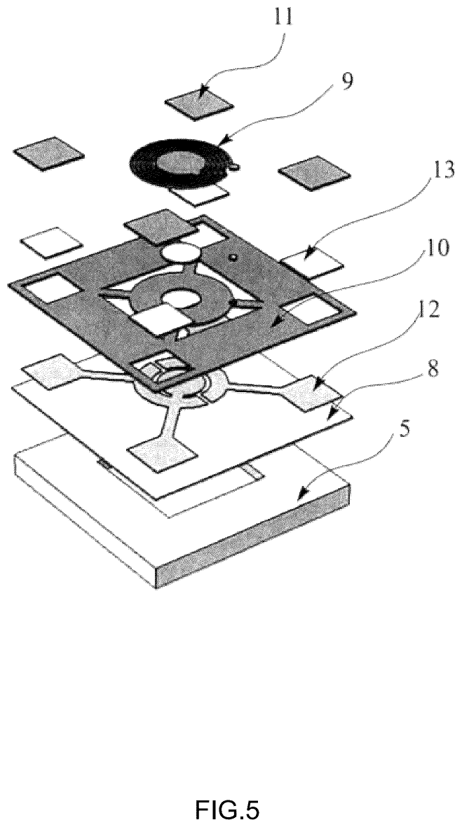

The structure of the present disclosure always involves a micro loudspeaker based on MEMS, and particularly relates to a structure of the movable part of the electrodynamic MEMS loudspeaker, as shown in FIG. 5. According to a second aspect, the movable part (3) of the electrodynamic MEMS loudspeaker (1) causes air pressure differences in the diaphragm (8) or the dynamic structure, and the movement may arise from rotation or flexibility. The diaphragm (8) is connected to the center of the diaphragm through an electrodynamic actuator and forced to move. To optimize the displacement of the diaphragm, an elastic material or PDMS material is used, which is suitable for maintaining linear movement of the diaphragm.

The thin connecting arms (12) are arranged in a way of individually isolating and then protected by the polyimide (10) to prevent cracking of the diaphragm during the movement. The polyimide (10) also acts as a dielectric layer that isolates the connecting arms (12) from the planar micro-coil (9).

The advantages of the movable part in the present example lie in that the movable part is related to the performance of the electrodynamic MEMS loudspeaker and is a symmetrical structure of a film-conductor connector. Further, a rigid polyimide diaphragm is suspended on a diagonal spring structure and uniformly distributed on the elastic diaphragm. Based on this structure, the diaphragm as an acoustic reproduction part can move like piston motion, and this structure differs from previous structures. Further, this structure enables to optimize a frequency bandwidth, thereby achieving a larger bandwidth. A multi-turn planar micro-coil structure can be fabricated at a top and/or bottom of the diaphragm in a single-layer or double-layer form to enhance efficiency of the MEMS loudspeaker. An optimized patterned surface (nano-texture) further enhances these characteristics by reducing acoustic distortion and improving system efficiency, particularly at higher frequencies.

In an example, structural changes allow for use of a longer coil, such that a resultant electromagnetic force is significantly enhanced, and stronger performance can be achieved even under low power conditions.

The electrodynamic MEMS loudspeaker operates based on micro-machining technology, and serves as an acoustic reproduction device, enabling to repeatedly vibrate the diaphragm with an electromagnetic system as a driver. The movement of the diaphragm causes pressure fluctuations in ambient air, and such fluctuations are converted into perceptible acoustic signals (audio frequency variations). Vibration of the diaphragm is driven by a motor drive system. Furthermore, the electrodynamic MEMS loudspeaker operates based on a Lorentz force driving principle. A Lorentz driver is capable of causing large displacements. Therefore, the Lorentz driver is configured for low-frequency acoustic reproduction in the MEMS loudspeaker.

The electrodynamic MEMS loudspeaker used in the present disclosure includes the planar micro-coil (a voice coil) and a permanent magnet system attached to the flexible diaphragm. When signal current passes through the voice coil, a force is generated in a magnetic field of the loudspeaker, which drives the movement of the diaphragm. According to a Lorentz force law (FLorentz) formula 1, this force is equal to a product of a magnetic flux density (B), a coil length (l), and time (I) when the current flows through the coil:

$$FLorentz = BlI \qquad ( 1 )$$

In the voice coil of the micro loudspeaker, electrons move (or oscillate) along a common cylindrical path at a constant speed, and an alternating magnetic field, known as a Biot-Savart field, is generated. The micro loudspeaker used in the present disclosure serves as a transducer, and converts electrical energy or signals (such as current) into mechanical (acoustic) energy. Without interaction between a static magnetic field and a magnetic field generated by continuously changing charges, acoustic output cannot be achieved.

Since a magnetic field strength of the permanent magnet is constant, low signal current needs to flow through the coil to generate a greater force and achieve low power consumption. In view of this, the coil can be usually designed to be relatively long. However, in consideration of size constraints in design and manufacturing of the MEMS micro loudspeaker, the coil of the present disclosure is relatively shorter than that of a traditional loudspeaker. Therefore, the current supplied to the relevant coil is deemed to be sufficiently high. In an example of the currently designed MEMS loudspeaker, the planar micro-coil functions as a micro voice coil, which can be a single-turn (single-loop) or multi-turn coil, such that a power amplifier current is needed to ensure complete operation of the system. Surface patterning on the micro-coil can also enhance an electromagnetic interaction, and the objective of improving efficiency and reducing power consumption is achieved by maximizing an effective contact area between the coil and the magnetic field.

The electrodynamic MEMS loudspeaker or the micro loudspeaker manufactured with micro-electro-mechanical machining technology is an electro-acoustic transducer that converts electrical signals into acoustic signals or sounds. Generally, the electrodynamic MEMS loudspeaker can be divided into two parts: a motor part and a mechanical acoustic part. The two parts are key assemblies for efficient operation of the electrodynamic MEMS loudspeaker. Therefore, these parts are deemed as essential components for acoustic reproduction and cannot be separated from other parts or omitted, otherwise, the entire system cannot work normally.

According to the present example, the movable part of the electrodynamic MEMS loudspeaker particularly includes the elastic diaphragm (8) fixed at the top of the silicon framework, and the connecting arms (12) are used to connect the planar micro-coil (9) to the contact pads (11). These connecting arms (12) of thin conductor are distributed diagonally at the center of the elastic diaphragm (8) for connecting the planar micro-coil (9) with the connecting arms (12) through the connectors (13) therebetween.

The connecting arms (12) of thin conductor are embedded in the center of the elastic diaphragm or the PDMS diaphragm, the connecting arms (12) are distributed diagonally, and protected by polyimide with the spring diaphragm structure. The polyimide with the spring diaphragm structure also acts as an insulating layer, and isolates the planar micro-coil (9) from the connecting arms (12).

The structure of the movable part (3) described above enables to generate an optimal acoustic pressure probability in the MEMS loudspeaker (1). This fact is attributed to presence of the elastic diaphragm (8), and pressure differences of air sealed at both ends of the diaphragm can be addressed to adapt to different environmental conditions. However, when the elastic diaphragm (8) is removed from the MEMS loudspeaker structure (1), a system of the MEMS loudspeaker can still operate normally and exhibit different performance parameters.

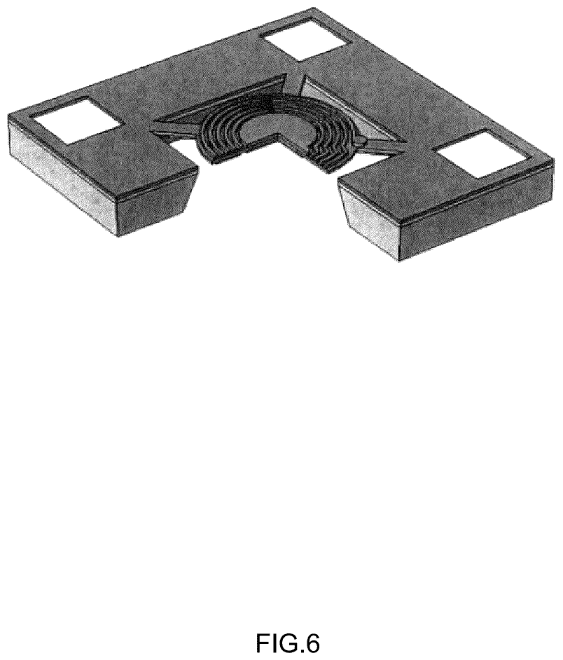

Therefore, in the present disclosure, when the elastic diaphragm (8) is removed from the MEMS loudspeaker structure (1), the system can still operate normally, and according to different examples of the present disclosure, the MEMS loudspeaker structure (1) exhibits significant differences, as shown in FIG. 6.

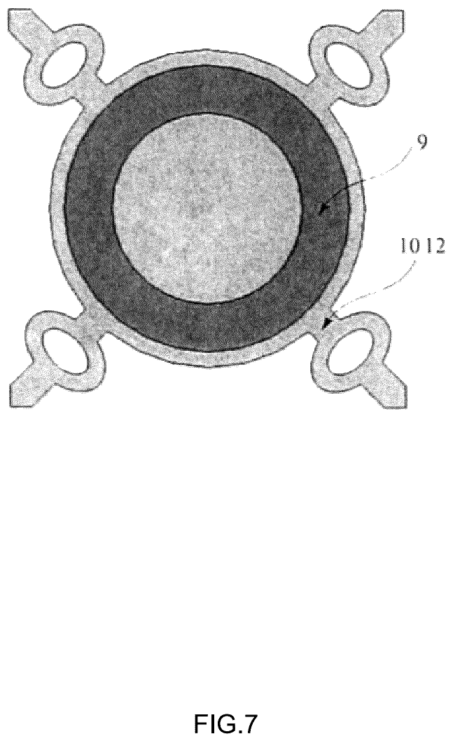

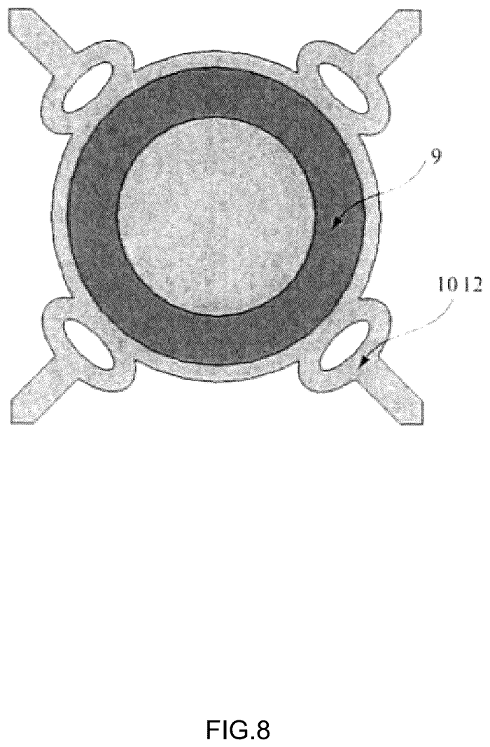

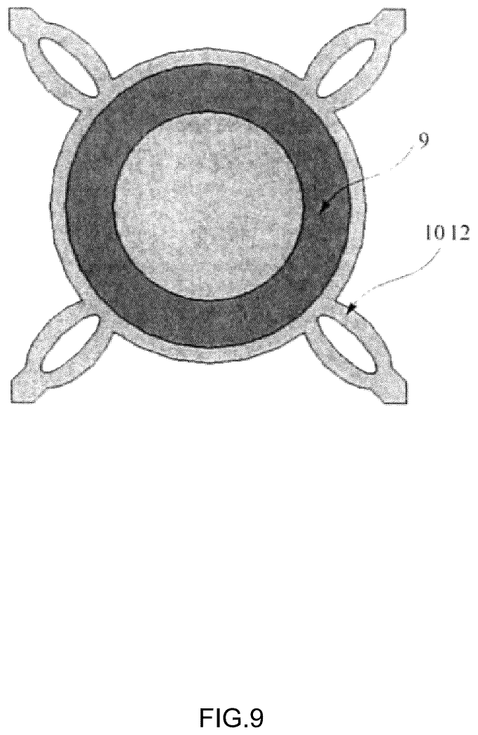

FIGS. 7-9 display an alternative arm structure configured for connecting a diaphragm layer formed by the polyimide (10) in the electrodynamic MEMS loudspeaker of the present disclosure, as shown in FIG. 2.

In an alternative example, the polyimide diaphragm is replaced with a transparent graphene diaphragm. Graphene is known for its being lightweight, high-strength and highly conductive, and features transparency and flexibility in acoustic performance. The transparent graphene enhances acoustic clarity and efficiency and maintains structural integrity. An ultra-low energy consumption of graphene helps to extend a battery life of a mobile and portable device. Optimization of the diaphragm enables to achieve high-frequency response and clearer acoustic reproduction and reduce distortion. The graphene material is lightweight, high-strength and transparent, and enables better acoustic clarity and enhanced high-frequency response. The high conductivity of graphene ensures minimal acoustic distortion, and the low energy consumption helps to extend the battery life of the portable device.

In an alternative example, a digital AI processor is directly integrated into the loudspeaker. In this way, the AI processor is capable of adjusting properties of the diaphragm (such as rigidity, tension, and flexibility) in real time according to audio signals and environmental factors (such as ambient noise, room acoustics, and temperature). Based on a machine learning algorithm, the loudspeaker is capable of continuously adapting its frequency response and dynamically balancing high and low frequencies to optimize auditory experiences. The AI system further has predictive learning capabilities and automatically selects preferred acoustic configurations according to characteristics of user behaviors.

In an alternative example, a single-layer diaphragm structure of the MEMS loudspeaker is changed into a multi-layer diaphragm structure, with nanotechnology employed. Nanoscale materials such as carbon nanotubes (CNT) or graphene sheets are used, which enhances sensitivity of the diaphragm and reduces energy consumption. Modular design of a loudspeaker architecture allows a user to replace or upgrade assemblies such as the diaphragm and the AI processor for customization or performance enhancement. A nanomaterial of a multi-layer structure such as the carbon nanotube (CNT) and the graphene sheet is introduced to replace a traditional single-layer diaphragm. The new architecture significantly enhances sensitivity of the diaphragm and reduces energy consumption.

In an alternative example, an intelligent energy harvesting system is introduced, which converts kinetic energy of diaphragm movement and environmental vibrations into electrical energy to supply power to an internal AI system and sensors of the loudspeaker, thereby eliminating the need of an external power source in regular use, such that the system is highly energy-efficient and environmentally friendly.

In an alternative example, an AI-enhanced manufacturing process is disclosed, and a real-time data-guided robot assembly line is utilized to optimize a production process of each assembly. Further, the process supports customizing acoustic characteristics of the loudspeaker according to user preferences or environmental conditions. An AI testing system ensures that all products conform to high-performance acoustic standards. The manufacturing process is significantly enhanced by an AI-driven robot assembly line, and data can be adjusted in real time to optimize the production of each assembly. A scalable manufacturing model enables to customize the acoustic characteristics of each MEMS loudspeaker according to consumer preferences or environmental needs. The AI testing system is integrated for production to ensure that each unit conforms to ideal acoustic performance standards.

It is evident to those skilled in the art that the present disclosure can be implemented in other specific forms without deviating from basic features. Similarly, specific naming and division of parts, modules, agents, managers, assemblies, functions, programs, actions, layers, features, properties, methodologies and other aspects are not mandatory or significant, and implementation mechanisms of the present disclosure or its features may have different names, divisions, and/or formats.

Therefore, the disclosure of the present disclosure is intended for illustrative content and does not limit the scope of the present disclosure, and the specific scope will be clearly defined in the following claims.

The foregoing descriptions are merely exemplary examples of the present disclosure, but are not intended to limit the present disclosure. Any modification, equivalent replacement or improvement derived within the spirit and principle of the present disclosure shall all fall within the protection scope of the present disclosure.

What is claimed is:

1. An electrodynamic micro-electromechanical system (MEMS) loudspeaker (1), wherein the MEMS loudspeaker (1) comprises at least two parts, and the two parts comprise at least a static part (2) and a movable part (3), wherein the static part (2) comprises a silicon framework (4) as a permanent magnet platform, at least an acoustic aperture (7), and a permanent magnet (6); the movable part (3) comprises at least an elastic square-shaped diaphragm (8), a single-layer planar micro-coil (9), a connector (10), and a plurality of contact pads (11); and a square and folded structure is formed by an interaction between a current-carrying planar coil (9) and a magnetic field produced by the permanent magnet (6), thereby generating a specific acoustic pressure around a front end of the diaphragm (8).

2. The electrodynamic MEMS loudspeaker (1) according to claim 1, wherein the diaphragm (8) is a vibrating diaphragm, and the diaphragm is a transparent graphene diaphragm.

3. A device of an electrodynamic MEMS loudspeaker (1), wherein the MEMS loudspeaker (1) comprises a static part (2), a movable part (3) and an acoustic generation mechanism; the static part (2) comprises a silicon framework (4), and the framework is configured as a platform for an acoustic aperture (7) and a permanent magnet (6); an elastic square-shaped diaphragm (8) is fixed at a top of the silicon framework (4) and is provided with a connector (10), and an arm formed by the connector (10) is configured to connects a planar micro-coil (9) and a plurality of contact pads (11); a plurality of connecting arms (12) of thin conductor are obliquely distributed at a center of the elastic square-shaped diaphragm (8) and are configured for connection with the planar micro-coil (9) through the plurality of the connecting arms (12); and the plurality of the connecting arms (12) of thin conductor are embedded in a center of at least one elastic square-shaped diaphragm (8).

4. The device according to claim 3, wherein the MEMS loudspeaker (1) comprises two micromachined silicon frameworks, wherein the first framework is configured as a micromachined flexible film on a silicon wafer, serving as an acoustic generation mechanism, and the second framework is a micromachined silicon wafer that serves as a permanent magnet platform.

5. The device according to claim 4, wherein the silicon frameworks are bonded together to form an integrated electrodynamic MEMS loudspeaker (1).
